(19) United States
(12) Patent Application Publication
(10) Pub. No.: US 2004/0049745 A1
(43) Pub. Date: Mar. 11, 2004

(54) Method and apparatus for waiving noise violations

(75) Inventors: Mohammed M. Rahman, Santa Clara, CA (US); Langya Yang, Sunnyvale, CA (US); Yongjun Zhang, Sunnyvale, CA (US); Victor C. Leung, Sunnyvale, CA (US); Hui Lu, Sunnyvale, CA (US); Shunjiang Xu, Sunnyvale, CA (US); Rambabu Pyapali, Cupertino, CA (US); Peter F. Lai, San Jose, CA (US); Chin-Chang G. Wu, Saratoga, CA (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/236,840

(22) Filed: Sep. 6, 2002

(51) Int. Cl. G06F 17/50

(52) U.S. Cl. 716/4

(57) ABSTRACT

The present invention describes a method and an apparatus for waiving noise violations during semiconductor integrated circuit design. The noise violations in a circuit area (e.g., an individual cell, block of cells or the like) are identified using a threshold look-up table. The threshold look-up table includes different thresholds for each circuit area. The threshold look-up table is generated using various cell related information including practical noise handling limits of each cell that can be higher than traditional noise limits. The information in the threshold look-up table helps eliminate benign noise violations and a new noise report is generated. The new noise report incorporates the practical noise handling capabilities of the cell under analysis and identifies actual noise violations in the semiconductor integrated circuit.

### CROSS-REFERENCE TO RELATED APPLICATION(S)

### BACKGROUND

1. Field of the Invention

The present invention relates to semiconductor integrated circuits design, more specifically to noise analysis in the semiconductor integrated circuits.

2. Description of the Related Art

Generally, in semiconductor integrated circuit designs, various tools are used to identify noise violations. Typically, noise violation identification tools analyze functional blocks in the semiconductor integrated circuits and identify the areas of noise within the integrated circuit by analyzing switching activities around a net and the net supported by the functional block (e.g., via a fanout report or the like). The noise violation identification tools generate and review the fanout report and based on certain generally defined criteria, identify a semiconductor integrated circuit area that has a potential for generating noise, in a noise violation report.

Typically, certain semiconductor cells can withstand more noise than generally acceptable limits. The noise violation reports generated by the existing tools can also include cells that practically can handle more noise than identified in the noise violation report. The noise violation reports generated by these tools are typically reviewed by design engineers. The design engineers filter benign noise violations from the noise violation reports. Depending upon the complexity of the integrated circuit, it can take extensive amount of engineers' time (e.g. hundreds of engineering hours per circuit or the like). A method and apparatus is needed to waive benign noise violation during the noise violation analysis of the semiconductor integrated circuits.

### SUMMARY

In one embodiment of the present invention, a method is employed in connection with an integrated circuit design. The method includes representing, for each of circuit elements of the integrated circuit design, respective noise related thresholds; and waiving noise violations that correspond to particular ones of the circuit elements based, at least in part, on the respective noise related thresholds. In some variations, the method identifies the respective noise thresholds based on one or more types of the circuit elements.

In some variations, the respective noise thresholds are identified based on one or more pin identifications of the circuit elements. In some variations, the representing of respective noise thresholds includes use of a threshold look-up table that includes entries associable with particular ones of the circuit elements. The method further includes calculating at least some of the respective noise related threshold based on user defined noise violation simulation for the circuit elements. In some variations, at least some of the respective noise thresholds are stored in a repository therefor. In some variations, the circuit elements include, or correspond to, cells from a logic or circuit library. In some variations, the circuit elements include a block or cluster of cells.

The foregoing is a summary and thus contains, by necessity, simplifications, generalizations and omissions of details. Consequently, those skilled in the art will appreciate that the summary is illustrative only and is not intended to be in any way limiting. Other aspects of the present invention, as defined solely by the claims, will become apparent in the detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a flow diagram illustrating an exemplary sequence of operations performed during a process of waiving noise violation according to an embodiment of the present invention.

FIG. 2 is a flow diagram illustrating an exemplary sequence of operations performed during a process of building and populating threshold look-up table according to an embodiment of the present invention.

The use of the same reference symbols in different drawings indicates similar or identical items.

### DESCRIPTION OF THE PREFERRED EMBODIMENT(S)

The present application describes a method and an apparatus for waiving noise violations for example, during semiconductor integrated circuit design. The noise violations in a circuit area (e.g., an individual cell, block of cells or the like) are identified using a threshold look-up table. The threshold look-up table includes thresholds that correspond to portions (e.g., cells or the like) of the integrated circuit. The threshold look-up table is generated using various cell related information including practical noise handling limits of each cell that can be higher than traditional noise limits. The information in the threshold look-up table helps identify and waive benign noise violations and a new noise report is generated. The new noise report incorporates the practical noise handling capabilities of the cell under analysis and identifies actual noise violations in the semiconductor integrated circuit.

Typically, particular portions of an integrated circuit are or composed of one or more cell instances that correspond to predefine logic or circuit elements from library thereof. Accordingly, much of the description herein uses standard cell logic design terminology. Nonetheless, person of skill in the art will recognize that techniques of the present invention may be employed in other environments, including integrated circuit design that employ little or no standard cell logic as long as waivable noise thresholds are established for relevant portions or features of the integrated circuit or design.

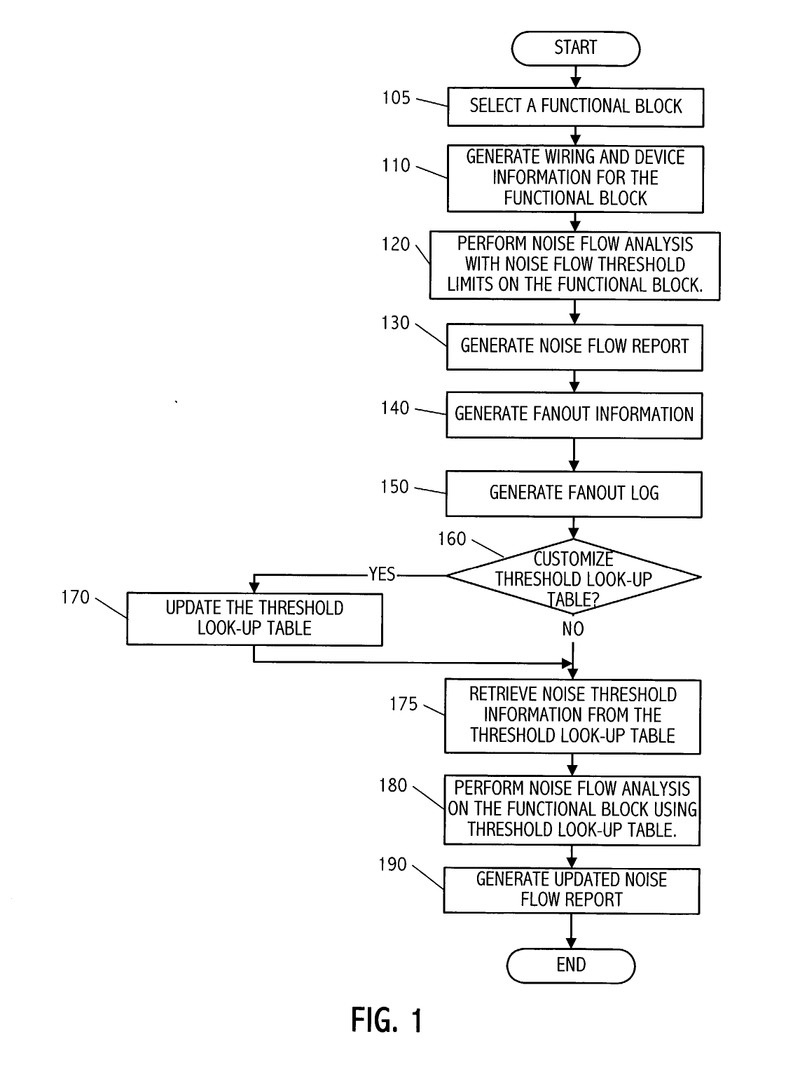

FIG. 1 is a flow diagram illustrating an exemplary sequence of operations performed during a process of waiving noise violations according to an embodiment of the present invention. While the operations are described in a particular order, the operations described herein can be performed in other sequential orders (or in parallel) as long as dependencies between operations allow. In general, a particular sequence of operations is a matter of design choice and a variety of sequences can be appreciated by persons of skill in art based on the description herein. Initially, the illustrated process selects a functional block (e.g., a cell, block of cells, clusters of cells, core, or the like) in the integrated circuit for noise violation analysis (105). The noise violation analysis can be done on a cell, a block of cell, entire circuit or the like.

The process generates the wiring and device information (e.g., netlist or the like) for the functional block (110). In general, wiring and device information can be generated using any of a variety of conventional techniques such as those employed by modern design tools. Next, the process performs conventional noise flow analysis on the functional block (120). The process then generates a noise flow report (130). The noise report can be generated using techniques known in the art. For example, noise reports are commonly provided by conventional analysis tools such as SPICE™ or the like. Typically, a noise report includes noise flow thresholds for a functional block and the like. The conventional noise violation report typically includes noise violations for the selected cell which may be considered “benign” based on experience. Techniques described herein facilitate waving such benign violations.

Referring to FIG. 1, the illustrated process generates a fanout report for the functional block (140). The process also generates a fanout log for the functional block (150). The fanout log includes the detailed information regarding fanout of the selected cell (e.g., errors, audits, waiving information for the selected cell, or the like). The fanout report and the fanout log can be generated using known techniques. For example, in some implementations, a fanout report and fanout log are generated by determining whether the new threshold look-up table needs to be customized based on the noise analysis (160). In general, the threshold look-up table can be dynamically updated during the noise violation analysis phase or the threshold look-up table can be updated after the noise violation analysis is completed. The threshold look-up table can be updated using conventional database update techniques. If the threshold look-up table needs updates, the process updates the threshold look-up table (170). The process proceeds to retrieve new noise threshold information from the threshold look-up table (175).

If the threshold look-up table does not need to be updated, the process proceeds to retrieve new noise threshold information from the threshold look-up table (175). One suitable threshold look-up table is described later in this application. The process analyzes noise violation for the selected cell using the conventional noise report, wiring and device report and the threshold look-up table (180). Such noise violation analysis typically operates as post-processing for a conventional noise violation process. The noise violation analysis is performed using the thresholds defined in the new threshold look-up table. Because the new thresholds are typically based on the actual worst-case simulations of the circuit elements (e.g., cells, blocks of cells or the like), use of the new threshold values tends to eliminate or reduce benign noise violations that are otherwise included in a noise violation report using the conventional approaches.

In some realizations, a noise failure criterion for the selected cell can be expressed in accordance with the following relationship:

Vₚₑₐₖ/V_{dd}<Threshold

where Vₚₑₐₖ is the amount of noise peak voltage on a given net and V_{dd} is the supply voltage for the given circuit. In the present realization, Vₚₑₐₖ is normalized as a percentage of supply voltage, V_{dd}. For purposes of illustration, for example, if Vₚₑₐₖ is given as 0.500 volts for the given net and the supply voltage, V_{dd}, is 1.7 volts then Vₚₑₐₖ for the given net is (0.5/1.7)*100 or approximately 29.41%. If the generalized noise threshold limit in the conventional noise tools for the receivers of the given net is 25% then the conventional noise tools will generate a noise violation for the given net. However, if the receiver of the given net can handle more noise, say for example, 31%, then the noise violation reported by the conventional tools will be benign. Thus, if the noise threshold for the given net is populated as 31% in the threshold look-up table then the noise violation reported by the conventional tools can be waived according to an embodiment of the present invention. While a particular noise voltage relation is described, one skilled in art will appreciate that any combination of noise related parameters (e.g., level of cross talk, inductance, capacitance, impedance or the like) can be employed to waive benign noise. Similarly, while a particular representation and normalization has been employed in the illustrative realization, other representations and/or conventions may be employed in other relations.

The process generates an updated noise report (190). The updated noise report filters out any benign noise violations. The updated noise report is based on the thresholds defined in the new threshold look-up table.

An Exemplary Threshold Look-Up Table

The new threshold look-up table is a repository of cell noise threshold information. The threshold look-up table includes information about noise threshold limits of various input pins of a device in the circuit. The threshold lookup table can be generated using various methods known in art combined with the noise violation analysis to simulate actual noise capacities of individual element (e.g., that of a cell, block of cells, clusters of cells, individual devices or the like). The fanout reports generated by the noise violation analysis can be used to determine which elements can be simulated to find the actual noise capacity. In general, the simulation of the elements of the integrated circuit for a given case (e.g., user defined simulated worst-case environment or the like) noise violation can be performed using automated or manual techniques known in the art.

Table 1 illustrates an exemplary implementation of threshold look-up table according to some embodiments of the present invention. A library representation for each circuit element (e.g., cell, net, device or the like) in the circuit is established or referenced. In general, the library contains information about the circuit element and any of a number of conventional representations are suitable. The library field in the threshold look-up table includes the assigned library names of the circuit elements. The ‘Element.Pin’ field of the threshold look-up table includes the element identification and a pin number where a particular net can be connected. A ‘LU/HD Threshold’ field defines the low-up (LU) and high-down (HD) noise thresholds for the given element and pin in a particular library.

TABLE 1
Threshold look-up table.

| Library | Element.Pin | LU/HD Threshold |
|---|---|---|
| abc17_el | xyz_rst_abc17_1_xxxx.d0 | 0.25/0.31 |
| . . . | . . . | . . . |

For purposes of illustration, in the present example, a library for a circuit element, a cell in the present example, is given as ‘abc17_e1’. The corresponding cell name is ‘xyzrst_abc17_{—}1_xxxx’ and the given particular pin number is ‘d0’. The low-up noise threshold for cell ‘xyz_rst_abc17_{—}1_xxxx’ at pin number ‘d0’ is given as 0.25% and the high-down noise threshold for the cell is given as 0.31%. The values in the LU/HD threshold field are populated as a result of a given test case (e.g., user defined simulated worst-case environment or the like) for the cell. In the present example, the threshold look-up table can be searched using the library name, cell name and the pin number. While a particular data structure is shown and described for the threshold look-up table, one skilled in art will appreciate that the threshold look-up table can be configured using various database definitions. Similarly, the number, size and descriptions of fields in the threshold look-up table can be varied to accommodate specific design simulation parameters.

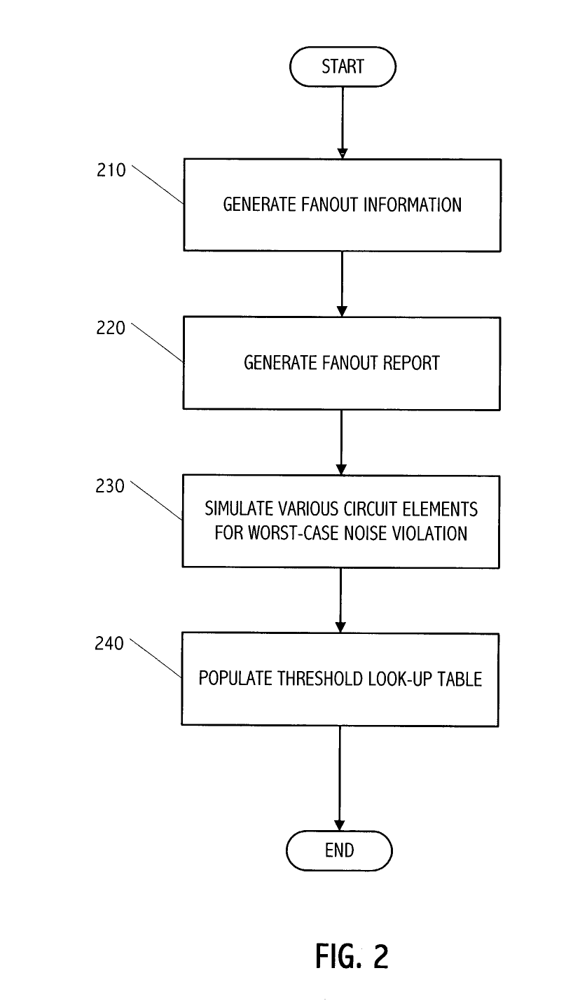

FIG. 2 is a flow diagram illustrating an exemplary sequence of operations performed during a process of building and populating threshold look-up table according to some embodiments of the present invention. The process can be used independently or in combination with the noise violation analysis process described herein. While the operations are described in a particular order, the operations described herein can be performed in other sequential orders (or in parallel) as long as dependencies between operations allow. In general, a particular sequence of operations is a matter of design choice and a variety of sequences can be appreciated by persons of skill in art based on the description herein. Initially, the process generates fanout information and fanout statistics for circuit elements (e.g., individual cell, group of cells, clusters of cells or the like) (210). The fanout information and statistics can be generated using techniques known in the art independently or in combination with the noise violation analysis process described herein.

The process generates fanout reports for the circuit elements (220). The fanout reports can include various information regarding circuit elements. The fanout reports can be generated using techniques known in the art or the noise violation analysis process described herein according to an embodiment of the present invention, independently or in combination thereof. The process then performs the worst-case simulation of the circuit elements for noise violation (230). The simulation can be automatic or manual using known techniques in the art. The simulation of circuit elements determines the actual noise capacity and noise thresholds for the circuit elements. The process then populates these noise thresholds into the threshold look-up table (240).

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A method for use in connection with an integrated circuit design, the method comprising:
representing, for each of a plurality of circuit elements of said integrated circuit design, respective noise related thresholds; and
waiving noise violations that correspond to particular ones of said plurality of circuit elements based, at least in part, on said respective noise related thresholds.

2. The method of claim 1, further comprising:
identifying said respective noise thresholds based on one or more types of said plurality of circuit elements.

3. The method of claim 1, further comprising:
identifying said respective noise thresholds based on one or more pin identifications of said plurality of circuit elements.

4. The method of claim 1, wherein said representing of respective noise thresholds comprises use of a threshold look-up table that includes entries associable with particular ones of said plurality of circuit elements.

5. The method of claim 1, further comprising:
calculating at least some of said respective noise related threshold based on user defined noise violation simulation for said plurality of circuit elements.

6. The method of claim 1, further comprising:
storing at least some of said respective noise thresholds in a repository therefore.

7. The method of claim 2, wherein said plurality of circuit elements comprises one or more of a cell, a block of cells and one or more clusters of cells.

8. A computer readable encoding of an integrated circuit design, the computer readable encoding comprises:
one or more design file media encoding representations of a plurality of functional blocks; and
one or more design file media encoding representations of circuit paths defined through representing, for each of a plurality of circuit elements of said integrated circuit design, respective noise related thresholds, and waiving noise violations that correspond to particular ones of said plurality of circuit elements based, at least in part, on said respective noise related thresholds.

9. The computer readable encoding of claim 8, wherein
each one of said one or more design file media are selected from a set of disk, tape or other magnetic, optical, semiconductor or electronic storage medium and a network, wireline, wireless or other communication medium.

10. The computer readable encoding of claim 8, wherein said representing of respective noise thresholds comprises use of a threshold look-up table that includes entries associable with particular ones of said plurality of circuit elements.

11. The computer encoding of claim 8, wherein said plurality of circuit elements comprises one or more of a cell, a block of cells and one or more clusters of cells.

12. An integrated circuit comprising:
a plurality of circuit elements; and
circuit paths defined through respective ones of said plurality of circuit elements, wherein a subset of said circuit paths is based on noise violation analysis of said plurality of circuit elements performed by representing, for each of said plurality of circuit elements of said integrated circuit design, respective noise related thresholds, and
waiving noise violations that correspond to particular ones of said plurality of circuit elements based, at least in part, on said respective noise related thresholds.

13. The integrated circuit of claim 12, wherein said respective noise thresholds are identified based on one or more types of said plurality of circuit elements.

14. The integrated circuit of claim 12, wherein said respective noise thresholds are identified based on one or more pin identifications of said plurality of circuit elements.

15. The integrated circuit of claim 12, wherein said plurality of circuit elements comprise one or more of a cell, a block of cells and one or more clusters of cells.

16. An apparatus for use in connection with an integrated circuit design comprising:
means for representing, for each of a plurality of circuit elements of said integrated circuit design, respective noise related thresholds; and
means for waiving noise violations that correspond to particular ones of said plurality of circuit elements based, at least in part, on said respective noise related thresholds.

17. The apparatus of claim 16, further comprising:
means for identifying said respective noise thresholds based on one or more types of said plurality of circuit elements.

18. The apparatus of claim 16, further comprising:
means for identifying said respective noise thresholds based on one or more pin identifications of said plurality of circuit elements.

19. The apparatus of claim 16, wherein said representing of respective noise thresholds comprises use of a threshold look-up table that includes entries associable with particular ones of said plurality of circuit elements.

20. The apparatus of claim 16, further comprising:
means for calculating at least some of said respective noise related threshold based on user defined noise violation simulation for said plurality of circuit elements.

21. The apparatus of claim 16, further comprising:
means for storing at least some of said respective noise thresholds in a repository therefore.

22. The apparatus of claim 16, wherein said plurality of circuit elements comprises one or more of a cell, a block of cells and one or more clusters of cells.

23. A system comprising:
a memory; and
a processor coupled to said memory, wherein said processor is configured to
represent, for each of a plurality of circuit elements of said integrated circuit design, respective noise related thresholds; and
waive noise violations that correspond to particular ones of said plurality of circuit elements based, at least in part, on said respective noise related thresholds.

24. The system of claim 23, wherein said processor is further configured to identify said respective noise thresholds based on one or more types of said
plurality of circuit elements.

25. The system of claim 23, wherein said processor is further configured to
identify said respective noise thresholds based on one or more pin identifications of said plurality of circuit elements.

26. The system of claim 23, wherein said processor is further configured to
calculate at least some of said respective noise related threshold based on user defined noise violation simulation for said plurality of circuit elements.

27. The system of claim 23, wherein said processor is further configured to
store at least some of said respective noise thresholds in a repository therefore.

28. The system of claim 23, wherein said plurality of circuit elements comprises one or more of a cell, a block of cells and one or more clusters of cells.
